(19) United States
(12) Patent Application Publication
(10) Pub. No.: US 2016/0025322 A1
(43) Pub. Date: Jan. 28, 2016

(54) LIGHT-EMITTING DEVICE

(71) Applicant: LITE-ON TECHNOLOGY CORPORATION, Taipei (TW)

(72) Inventors: Chun-Tao CHEN, Taipei (TW); Wen-Kwei LIANG, Taipei (TW); Cheng-Yu HSIEH, Taipei (TW)

(73) Assignee: LITE-ON TECHNOLOGY CORPORATION, Taipei (TW)

(21) Appl. No.: 14/567,535

(22) Filed: Dec. 11, 2014

(30) Foreign Application Priority Data
Jul. 24, 2014 (TW) 103125281

(51) Int. Cl. F21V 29/77; F21K 99/00; F21V 29/83

(52) U.S. Cl. CPC F21V 29/773; F21V 29/83; F21K 9/10

(57) ABSTRACT

A light-emitting device includes a single-piece heat dissipation element, a circuit board and an electroinsulating casing. The single-piece heat dissipation element includes a carrier portion and a fin portion. The circuit board is configured on the carrier portion. The electroinsulating casing encapsulates the carrier portion and the fin portion.

This application claims the benefit of Taiwan application Serial No. 103125281, filed Jul. 24, 2014, the subject matter of which is incorporated herein by reference.

### BACKGROUND OF THE INVENTION

1. Field of the Invention

The invention relates in general to a light-emitting device, and more particularly to a light-emitting device having a heat dissipation element.

2. Description of the Related Art

In general, a conventional light-emitting device generates heat when emitting. The heat is convected to environment through a heat conduction casing.

However, the structure of the heat conduction casing generally complicate, and thus a casting process is needed to form the casing. As a result, the whole production process of the heat conduction casing is complicated either in design stage or in manufacturing stage, and in addition, the weight of the heat conduction casing is heavy and the cost is relatively high.

### SUMMARY OF THE INVENTION

The invention is directed to a light-emitting device, a single-piece heat dissipation element of the light-emitting device may reduce the complexity of the design and the manufacturing.

According to one embodiment of the present invention, a light-emitting device includes a single-piece heat dissipation element, a circuit board and an electroinsulating casing. The single-piece heat dissipation element includes a carrier portion and a fin portion. The circuit board is configured on the carrier portion. The electroinsulating casing encapsulates the carrier portion and the fin portion of the single-piece heat dissipation element.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1A illustrates a schematic diagram of a light-emitting device according to an embodiment of the invention;

FIG. 1B illustrates a cross-sectional view of the light-emitting device along a direction 1B-1B′ of FIG. 1A;

FIG. 2A illustrates a top view of the light-emitting device of FIG. 1A;

FIG. 2B illustrates a cross-sectional view of the light-emitting device along a direction 2B-2B′ of FIG. 2A;

FIG. 3 illustrates a schematic diagram of the single-piece heat dissipation element of FIG. 1B;

FIG. 4 illustrates a cross-sectional view of the electroinsulating casing along a direction 4-4′ of FIG. 1A;

FIG. 5 illustrates an unfolding diagram of the single-piece heat dissipation element of FIG. 3;

FIG. 6 illustrates a cross-sectional view of the light-emitting device along a direction 6-6′ of FIG. 2A;

FIG. 7 illustrates a schematic diagram of a single-piece heat dissipation element according to another embodiment of the invention;

FIG. 8 illustrates an unfolding diagram of the single-piece heat dissipation element of FIG. 7;

FIG. 9A illustrates a schematic diagram of a light-emitting device according to another embodiment of the invention;

FIG. 9B illustrates a cross-sectional view of the light-emitting device along a direction 9B-9B′ of FIG. 9A;

FIG. 10 illustrates a cross-sectional view of the single-piece heat dissipation element and the electroinsulating casing along a direction 10-10′ of FIG. 9A;

FIG. 11A illustrates a schematic diagram of a light-emitting device according to another embodiment of the invention;

FIG. 11B illustrates a cross-sectional view of the light-emitting device along a direction 11-11B′ of FIG. 11A;

FIG. 12A illustrates an unfolding diagram of a single-piece heat dissipation element according to another embodiment of the invention;

FIG. 12B illustrates a folding diagram of the single-piece heat dissipation element of FIG. 12A;

FIG. 13A illustrates an unfolding diagram of a single-piece heat dissipation element according to another embodiment of the invention; and

FIG. 13B illustrates a folding diagram of the single-piece heat dissipation element of FIG. 13A.

### DETAILED DESCRIPTION OF THE INVENTION

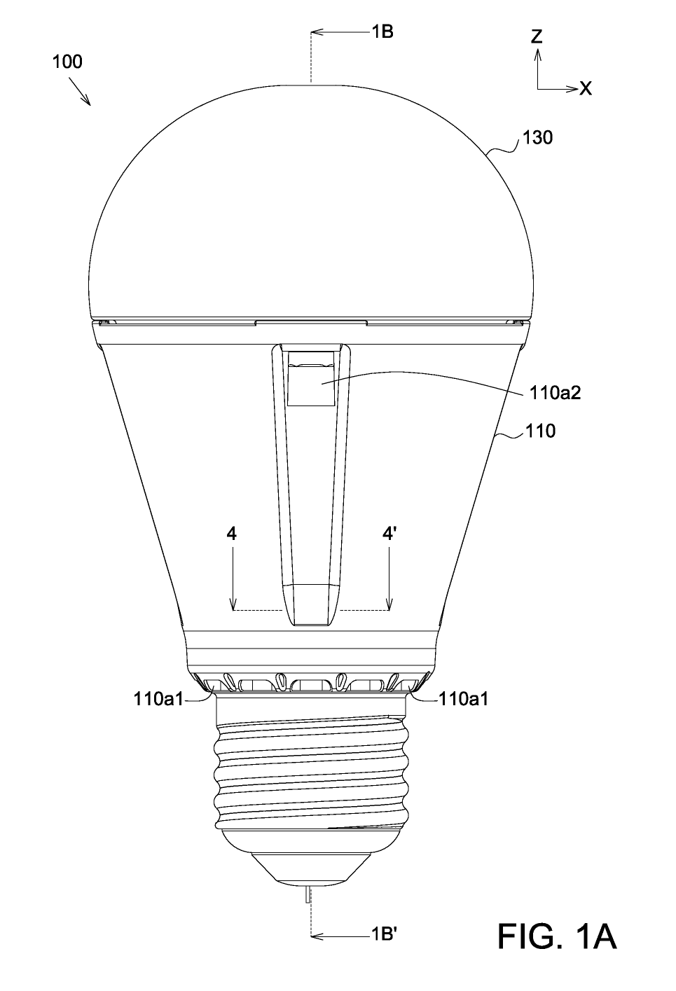

As shown in FIGS. 1A and 1B, in one embodiment, the light-emitting device 100 may be a light bulb, but not limited to, in another embodiment, the light-emitting device 100 may be any kind of illuminating device. The light-emitting device 100 includes an electroinsulating casing 110, a light-emitting element 120, a light cover 130, a driver 140, a single-piece heat dissipation element 150 and a circuit board 160.

The electroinsulating casing 110 encapsulates at least a portion of an outer surface of the single-piece heat dissipation element 150, and accordingly the single-piece heat dissipation element 150 may be prevented from being detached from the electroinsulating casing 110 easily, and the single-piece heat dissipation element 150 may be prevented from being electrically short with any element other than the single-piece heat dissipation element 150.

The light-emitting element 120 is disposed on the circuit board 160 and electrically connected to the driver 140. The driver 140 may control the emitting of the light-emitting element 120. The light emitted by the light-emitting element 120 is outwardly emitted from the light cover 130, such that the light-emitting device 100 provides an illuminating function. In addition, the light-emitting element 120 may generate heat when emitting. The heat may be conducted to the electroinsulating casing 110 through the circuit board 160 and the single-piece heat dissipation element 150, and then be convected to environment through the electroinsulating casing 110. The light-emitting element 120 may be, for example, a light-emitting diode (LED), but not limited to. The light-emitting device 100 may include a plurality of LED light sources with either the same or different light colors. The LED light sources may be controlled by the respective driver 140 to perform required illuminating function, such as different illuminating shape or illuminating color.

The electroinsulating casing 110 is formed by a material, such as plastic or other electroinsulating material. The electroinsulating casing 110 includes a plurality of first convection holes 110a1 and a plurality of second convection holes 110a2. The first convection holes 110a1 are positioned at a lower portion of the electroinsulating casing 110 and penetrate the electroinsulating casing 110. The second convection holes 110a2 are positioned at an upper portion of the electroinsulating casing 110 and penetrate the electroinsulating casing 110. The single-piece heat dissipation element 150 is located between the first convection holes 110a1 and the second convection holes 110a2. As a result, airflow G1 may flow between the first convection holes 110a1 and the second convection holes 110a2 for dissipating the heat from the single-piece heat dissipation element 150. Furthermore, the heat generated by the light-emitting element 120 may be conducted to the single-piece heat dissipation element 150 through the circuit board 160, and then convected to environment by the airflow G1.

In addition, the second convection holes 110a2 and the light-emitting element 12 are substantially in the same height and the light-emitting element 120 is surrounded by the second convection holes 110a2. As a result, although not shown in figures, the airflow G1 may flow among the second convection holes 110a2 for dissipating the heat from the circuit board 160 and the light-emitting element 120 along a transverse direction.

As shown in FIG. 1B, the light cover 130 includes a transparent shell 131 and a flange 132, wherein the flange 132 has a ring-shape and is connected to an opening of the transparent shell 131. The flange 132 is projected toward the inside of the light cover 130 and has an engaging recess 132r. The electroinsulating casing 110 includes a plurality of protrusions 111 projected from an inner surface of the electroinsulating casing 110. The light cover 130 may be prevented from being detached from the electroinsulating casing 110 by engaging the protrusions 111 and the engaging recesses 132r.

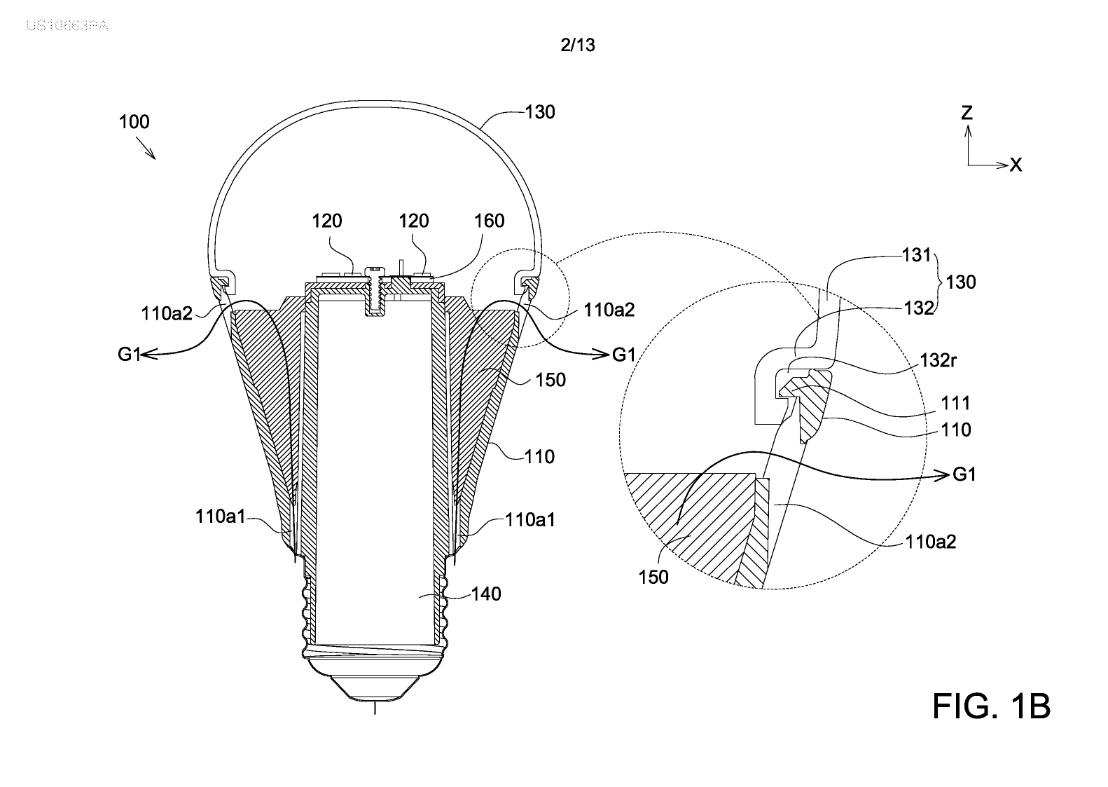

Refer to FIGS. 2A and 2B, FIG. 2A is a top view of the light-emitting device of FIG. 1A, and FIG. 2B is a cross-sectional view of the light-emitting device along a direction 2B-2B′ of FIG. 2A. A convection gap P1 is formed between an outer surface 132s of the flange 132 and an inner surface 110s of the electroinsulating casing 110. The airflow G1 may flow between the convection gap P1 and the first convection holes 110a1 (shown in FIG. 1B) and between the convection gap P1 and the second convection holes 110a2 (shown in FIG. 1B) for convecting the heat from the single-piece heat dissipation element 150 to environment.

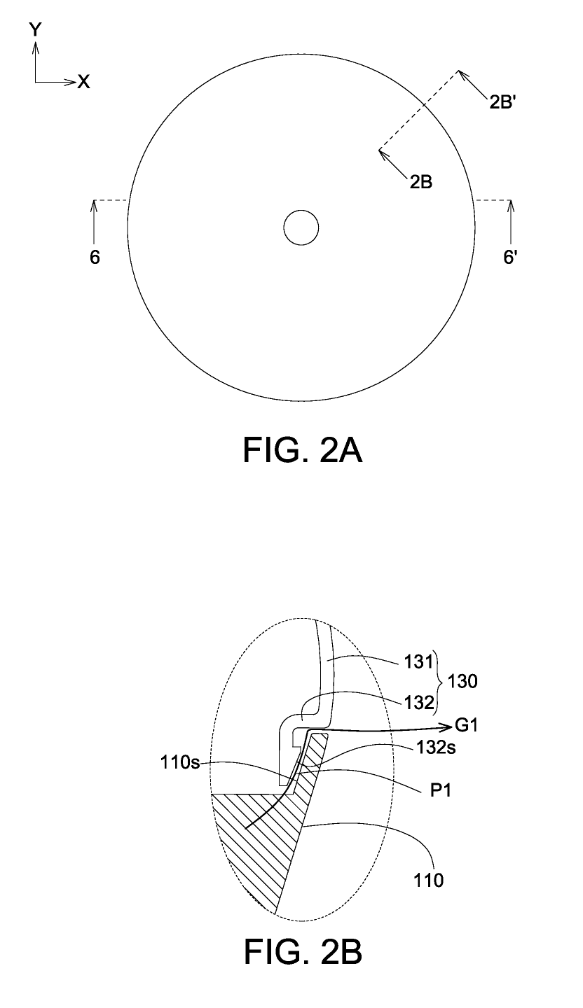

FIG. 3 is a schematic diagram of the single-piece heat dissipation element of FIG. 1B. In one embodiment, the single-piece heat dissipation element 150 may be a one-piece heat dissipation component, and accordingly cost of assembling and manufacturing may be reduced. The single-piece heat dissipation element 150 includes a carrier 151 and a plurality of fin portions 152 connected to the carrier 151, wherein the carrier 151 is substantially extended along the plane XY and the fin portions 152 are substantially extended along the Z-axis, and wherein, the Z-axis is an optical axis for example. The aforementioned circuit board 160 is configured on the carrier 151, and the electroinsulating casing 110 encapsulates at least a portion of an outer surface of the carrier 151 of the single-piece heat dissipation element 150 and at least a portion of an outer surface of each fin portion 152.

Each fin portion 152 is connected to the carrier 151 and is substantially vertical to the carrier 151; however, such exemplification is not meant to be for limiting. In another embodiment, an angle included between the fin portion 152 and carrier 151 may not be equal to 90 degrees. Each fin portion 152 includes an axial portion 1521, a first radial portion 1522 and a second radial portion 1523, wherein the axial portion 1521 is substantially extended along the Z-axis, and the first radial portion 1522 and the second radial portion 1523 are outwardly extended from a first side of the axial portion 1521 and a second side of the axial portion 1521 respectively, such that the first radial portion 1522 and the second radial portion 1523 are arranged in an irradiation shape.

In addition, each fin portion 152 further includes two circumferential portions 1524, each circumferentially (for example, around the Z-axis) extending from the first radial portion 1522 and the second radial portion 1523 respectively. The circumferential portions 1524 may stabilize a relative position between the single-piece heat dissipation element 150 and the electroinsulating casing 110.

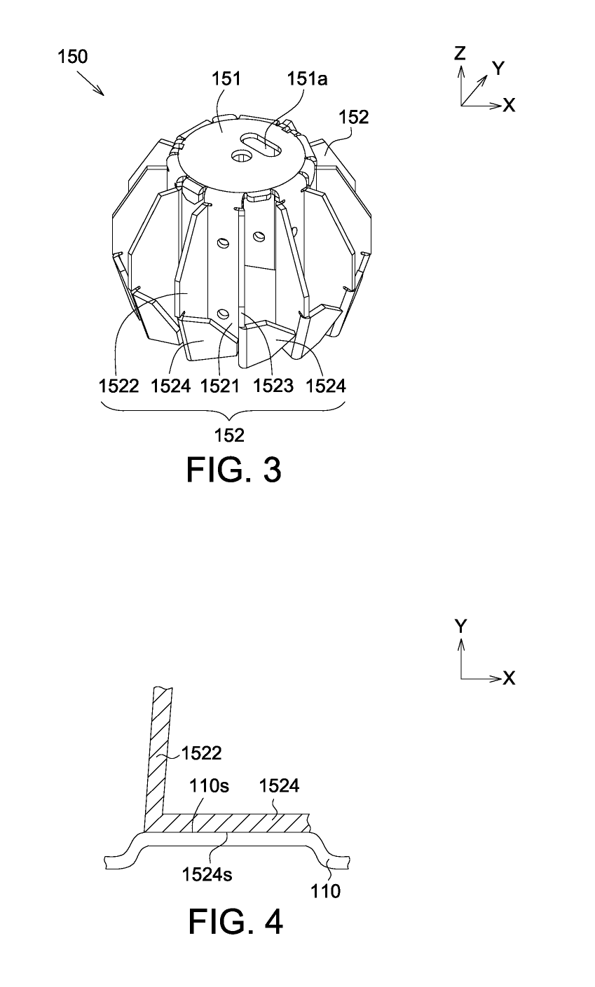

FIG. 4 is a cross-sectional view of the electroinsulating casing along a direction 4-4′ of FIG. 1A. An outer surface 1524s of each circumferential portion 1524 contacts with the inner surface 110s of the electroinsulating casing 110, and the outer surface 1524s of each circumferential portion 1524 provides an area contacting with the electroinsulating casing 110, and accordingly a stabilization of the relative position between the single-piece heat dissipation element 150 and the electroinsulating casing 110 may be promoted. Under such design, the single-piece heat dissipation element 150 may be placed into the electroinsulating casing 110 after the electroinsulating casing 110 is separately completed; however, such exemplification is not meant to be for limiting. In another embodiment, during the forming process of the electroinsulating casing 110 by way of injection molding, the single-piece heat dissipation element 150 may be pre-placed into an injection mold which used to inject the electroinsulating casing 110, such that the electroinsulating casing 110 may encapsulate at least a portion of the outer surface of the single-piece heat dissipation element 150 after the injection process.

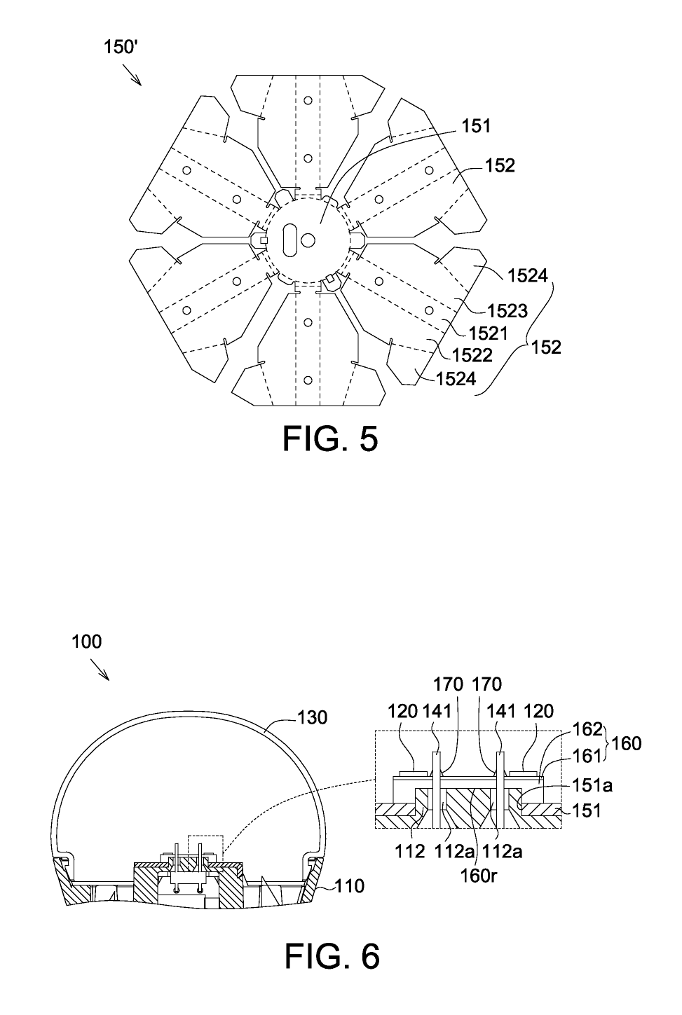

FIG. 5 is an unfolding diagram of the single-piece heat dissipation element of FIG. 3. In terms of forming method of the single-piece heat dissipation element 150, a single-piece unfolding sheet 150′ may be shaped into the single-piece heat dissipation element 150 of FIG. 5 by using sheet metal pressing. After the sheet pressing, the fin portion 152 and the carrier 151 are formed together in one-time only procedure. Then, the single-piece unfolding sheet 150′ may be bent as the single-piece heat dissipation element 150 of FIG. 3. Since the single-piece heat dissipation element 150 is formed by the sheet metal pressing, the structure of the single-piece heat dissipation element 150 is simpler and the weight of the single-piece heat dissipation element 150 is lighter (in comparison with casting process). In terms of material of the single-piece heat dissipation element 150, in one embodiment, the single-piece heat dissipation element 150 may be formed by a material, such as copper, aluminum or a combination thereof, but not limited to.

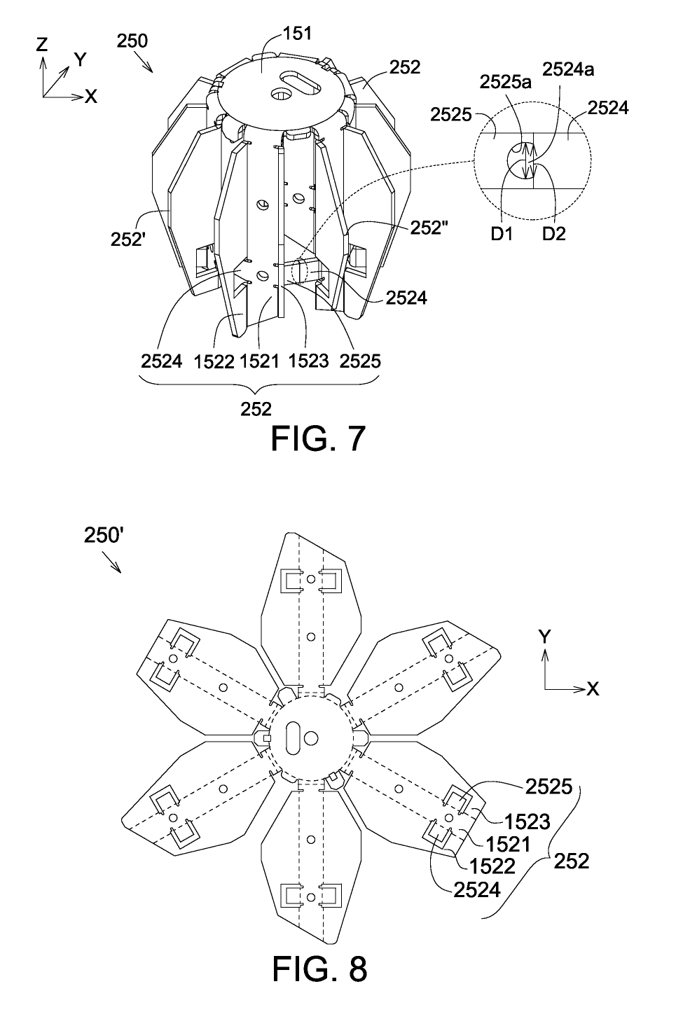

FIG. 6 is a cross-sectional view of the light-emitting device along a direction 6-6′ of FIG. 2A. The driver 140 includes two conductive wires 141. The electroinsulating casing 110 further includes an isolation portion 112 passing through a through hole 151a of the carrier 151 and the isolation portion 112 has two through holes 112a. The two conductive wires 141 pass through two through holes 112a respectively and two conductive wires 141 are extended to and electrically connected with the circuit board 160. The isolation portion 112 is configured to isolate the conductive wire 141 and the carrier 151, and accordingly the carrier 151 is prevented from being electrically short with the conductive wires 141. The electroinsulating casing 110 further includes two welding points 170 each being welded to a circumference of the corresponding conductive wire 141 for electrically connecting the corresponding conductive wire 141 and a circuit (not shown) established on the circuit board 160.

The circuit board 160 has a recess 160r. A portion of the isolation portion 112 is located within the through hole 151a, and the other portion of the isolation portion 112 is located within the recess 160r. Due to the design of the recess 160r, the isolation portion 112 is prevented from interfering with a physical material of the circuit board 160, and thus the isolation portion 112 may be prevented from jacking the circuit board 160 and negatively affecting the position of the circuit board 160.

In addition, the circuit board 160 is, for example, a metal core PCB (MCPCB). The circuit board 160 includes an insulation layer 161 and a heat conduction layer 162, wherein the light-emitting element 120 is disposed on the insulation layer 161. In one embodiment, the heat conduction layer 162 is an aluminum layer and has the recess 160r for receiving the isolation portion 112.

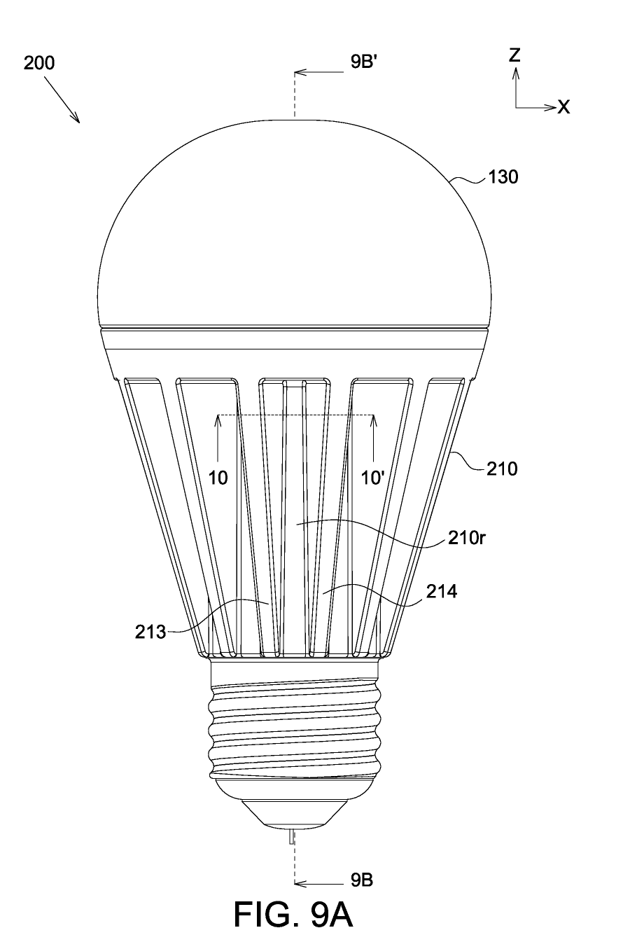

FIG. 7 is a schematic diagram of a single-piece heat dissipation element according to another embodiment of the invention. In comparison with the single-piece heat dissipation element 150 aforementioned, the single-piece heat dissipation element 250 shown in FIG. 7 omits two circumferential portions 1524. The single-piece heat dissipation element 250 includes the carrier 151 and a plurality of fin portions 252 connecting to the carrier 151, wherein an angle is included between each fin portion 252 and the carrier 151. Each fin portion 252 includes the axial portion 1521, the first radial portion 1522 and the second radial portion 1523, wherein the first radial portion 1522 and the second radial portion 1523 are outwardly extended from a first side and a second side of the axial portion 1521 respectively, such that the first radial portion 1522 and the second radial portion 1523 are arranged in an irradiation shape.

Each fin portion 252 further includes a first fixing portion 2524 and a second fixing portion 2525. The first fixing portion 2524 is connected to the first radial portion 1522 and is extended toward a direction away from the first radial portion 1522 for connecting the second fixing portion 2525 of the adjacent fin portion 252′ (can't be viewed due to viewing angle). The second fixing portion 2525 is connected to the second radial portion 1523 and is extended toward a direction away from the second radial portion 1523 for connecting the first fixing portion 2524 of the adjacent fin portion 252″. As a result, the adjacent two fin portions may be connected to each other, and accordingly the rigidity of the single-piece heat dissipation element 250 may be increased. Since the rigidity of the single-piece heat dissipation element 250 is enhanced, the single-piece heat dissipation element 250 may be stably pre-placed in the injection mold of the electroinsulating casing during the injection molding process.

As shown in FIG. 7, the first fixing portion 2524 and the second fixing portion 2525 are circumferentially extended. The first fixing portion 2524 includes a protrusion 2524a, the second fixing portion 2525 includes a notch 2525a, and the protrusion 2524a is engaged with the notch 2525a. In the present embodiment, an outer diameter D1 of the protrusion 2524a expanded in a direction toward the notch 2525a, and an inner diameter D2 of the notch 2525a shrinking in a direction toward the protrusion 2524a. As a result, the protrusion 2524a may be engaged within the notch 2525a and thus the protrusion 2524a and the notch 2525a are not easy to be detached. In the present embodiment, a shape of the protrusion 2524a is complementary to a shape of the notch 2525a; however, such exemplification is not meant to be for limiting. In addition, the connection way between the first fixing portion 2524 and the second fixing portion 2525 is not limited to this embodiment of the invention. For example, the connection way may include screwing, engaging, welding, riveting, gluing, other temporary or permanent way. In addition, the connection way between the first fixing portion 2524 and the second fixing portion 2525 is not limited to mechanical way, and a chemical way may be used.

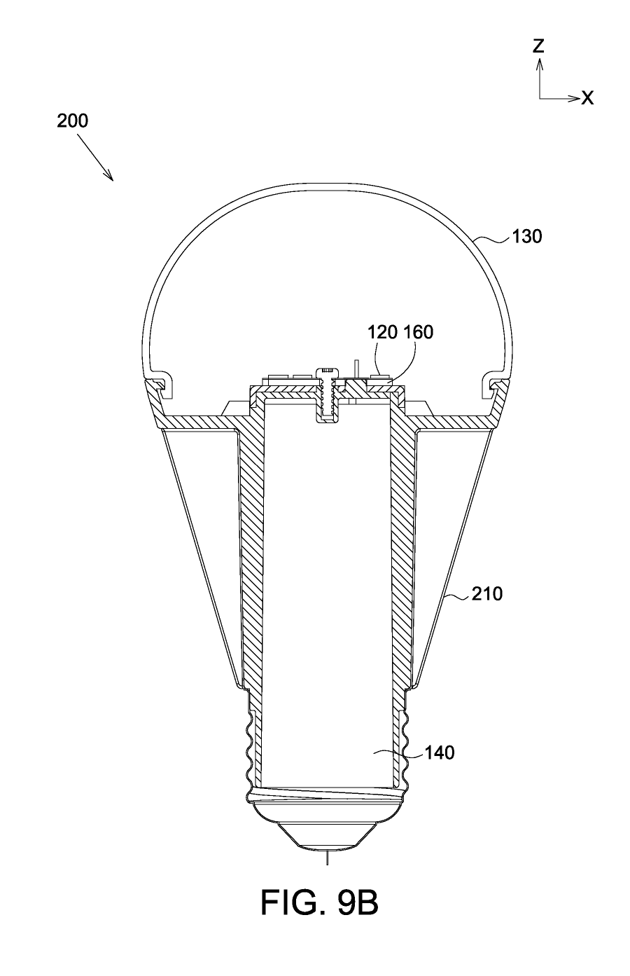

FIG. 8 is an unfolding diagram of the single-piece heat dissipation element of FIG. 7. In terms of material of the single-piece heat dissipation element 250, the single-piece heat dissipation element 250 may be formed by a material such as copper, aluminum or a combination thereof.

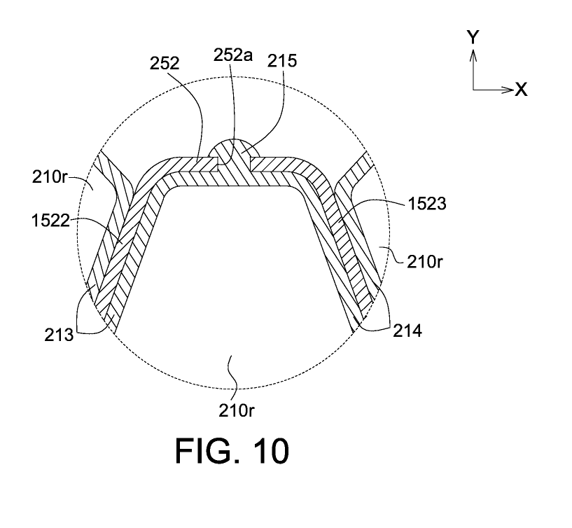

Refer to FIGS. 9A and 9B, FIG. 9A is a schematic diagram of a light-emitting device according to another embodiment of the invention, and FIG. 9B is a cross-sectional view of the light-emitting device along a direction 9B-9B′ of FIG. 9A. The light-emitting device 200 includes an electroinsulating casing 210, the light-emitting element 120, the light cover 130, the driver 140, the single-piece heat dissipation element 250 and the circuit board 160.

As shown in FIGS. 9A and 7, since the single-piece heat dissipation element 250 shown in FIG. 7 omits the circumferential portions 1524, during the injection molding process, the material of the electroinsulating casing 210 is prevented from being blocked by the circumferential portions 1524 and thus may flow to the location which between the first radial portion 1522 and the second radial portion 1523 for encapsulating the first radial portion 1522 and the second radial portion 1523. A heat dissipation recess 210r is formed between the materials which encapsulating the first radial portion 1522 and the second radial portion 1523. In particularly, the electroinsulating casing 210 includes a plurality of first covering portions 213 and second covering portions 214 (as shown in FIG. 9A). The first covering portions 213 and the second covering portions 214 respectively encapsulate the first radial portion 1522 and the second radial portion 1523 (as shown in FIG. 7) of the same fin portion 252. The first covering portions 213 and the second covering portions 214 are isolated from each other and form the heat dissipation recess 210r. Due to the indentation design of the heat dissipation recess 210r, a heat dissipation area of the electroinsulating casing 210 is increased, and heat dissipation efficiency may be improved.

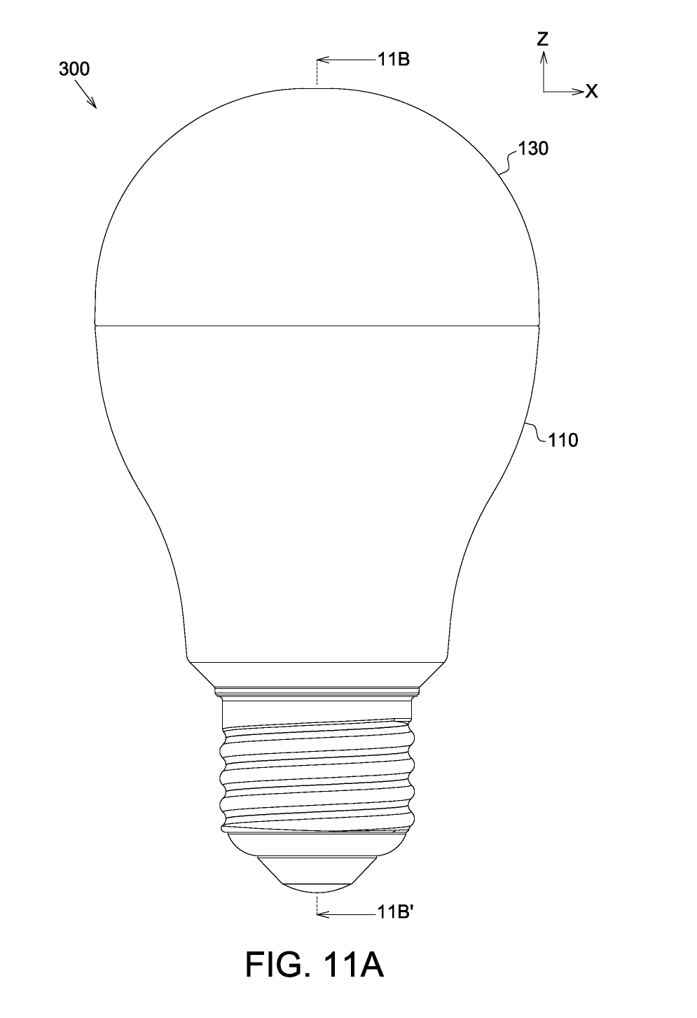

FIG. 10 is a cross-sectional view of the single-piece heat dissipation element and the electroinsulating casing along a direction 10-10′ of FIG. 9A. The electroinsulating casing 210 has an engaging portion 215 engaged with a fixing hole 252a of each fin portion 252 for stabilizing a relative position between the single-piece heat dissipation element 250 and the electroinsulating casing 210. In terms of forming method of the electroinsulating casing 210, the single-piece heat dissipation element 250 may be pre-placed in the injection mold; after the injection molding, the electroinsulating casing 210 encapsulates at least a portion of the outer surface of the single-piece heat dissipation element 250, and a portion of material (for example, the engaging portion 215) of the electroinsulating casing 210 flows through the fixing hole 252a. After the portion of material (for example, the engaging portion 215) is solidified, the material within the fixing hole 252a forms the engaging portion 215.

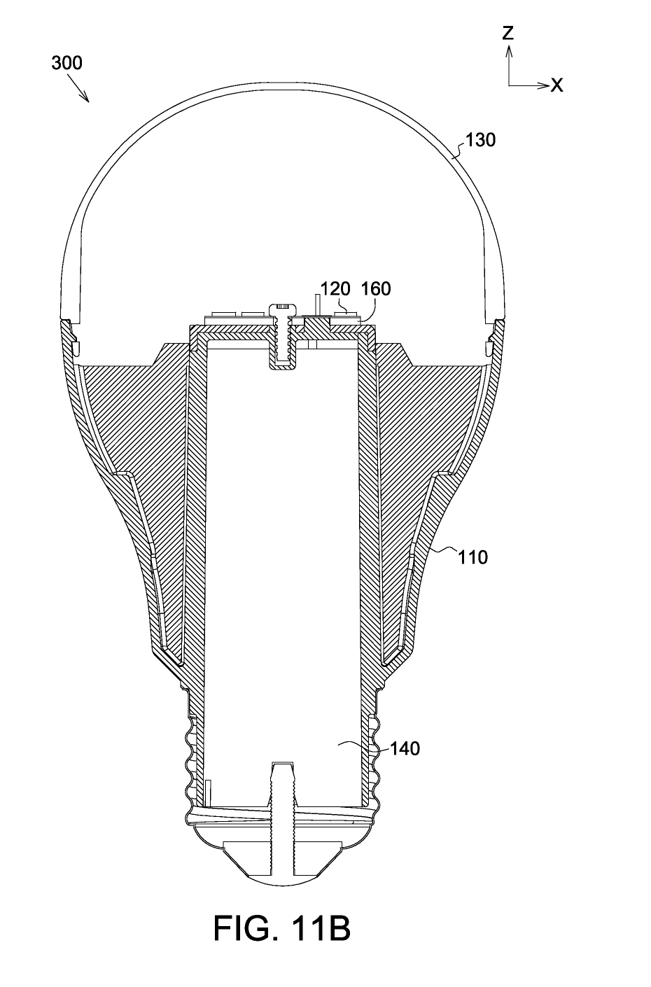

Refer to FIGS. 11A and 11B, FIG. 11A is a schematic diagram of a light-emitting device according to another embodiment of the invention, and FIG. 11B is a cross-sectional view of the light-emitting device along a direction 11-11B′ of FIG. 11A.

The light-emitting device 300 includes an electroinsulating casing 310, the light-emitting element 120, the light cover 130, the driver 140, the single-piece heat dissipation element 150 (or single-piece heat dissipation element 250 shown in FIG. 7) and the circuit board 160.

In comparison with the light-emitting device of aforementioned embodiment, the electroinsulating casing 310 may omit any convection hole, engaging hole and recess, such that no hollow or indentation formed on the sidewall of the electroinsulating casing 310, and accordingly the smooth surface of the electroinsulating casing 310 may be formed. For example, in comparison with the aforementioned light-emitting device 100, the electroinsulating casing 310 of the light-emitting device 300 may omit the first convection hole 110a1 and the second convection hole 110a2. In comparison with the aforementioned light-emitting device 200, the electroinsulating casing 310 of the light-emitting device 300 may omit the heat dissipation recess 210r. Since the first convection hole 110a1, the second convection hole 110a2 and the heat dissipation recess 210r may be omitted, the outer contours of the electroinsulating casing 310 may be smooth.

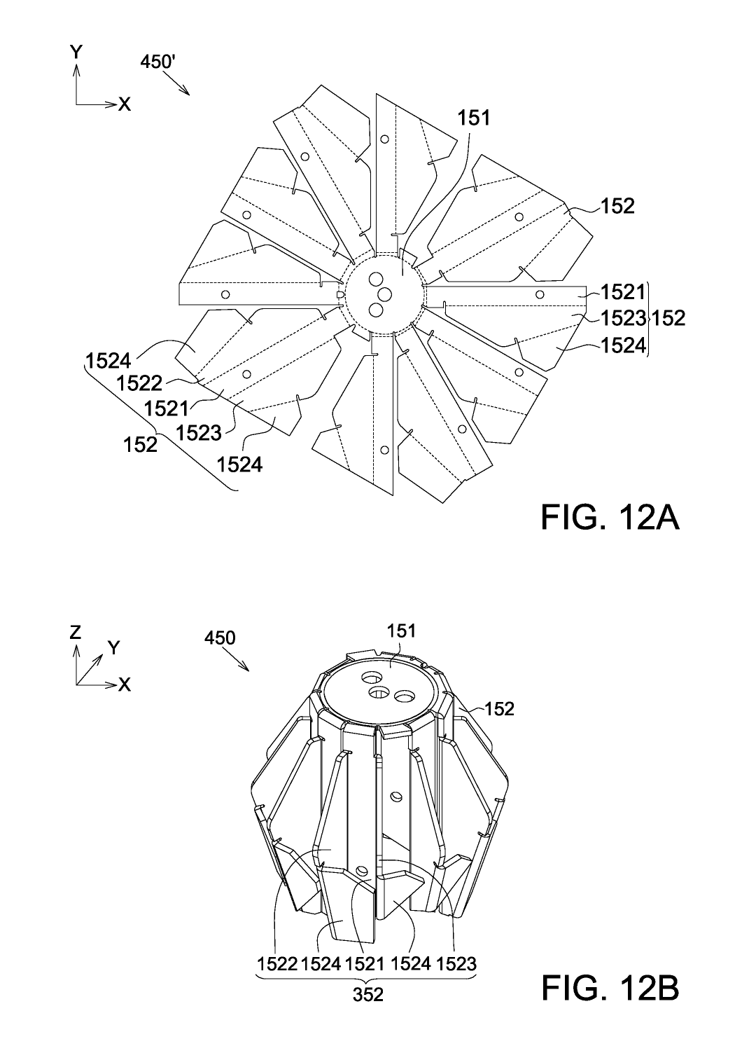

Refer to FIGS. 12A and 12B, FIG. 12A is an unfolding diagram of a single-piece heat dissipation element according to another embodiment of the invention, and FIG. 12B is a folding diagram of the single-piece heat dissipation element of FIG. 12A.

In comparison with the single-piece heat dissipation element 150 and 250, more heat conduction paths may be established by the single-piece heat dissipation element 450 or the unfolding sheet 450′ in this embodiment. In particularly, the number of the axial portions 1521 of the heat the single-piece heat dissipation element 150 is six, and the number of the axial portions 1521 of the heat the single-piece heat dissipation element 450 of the present embodiment is ten. By increasing the number of the axial portions 1521, the heat dissipation efficiency may be improved.

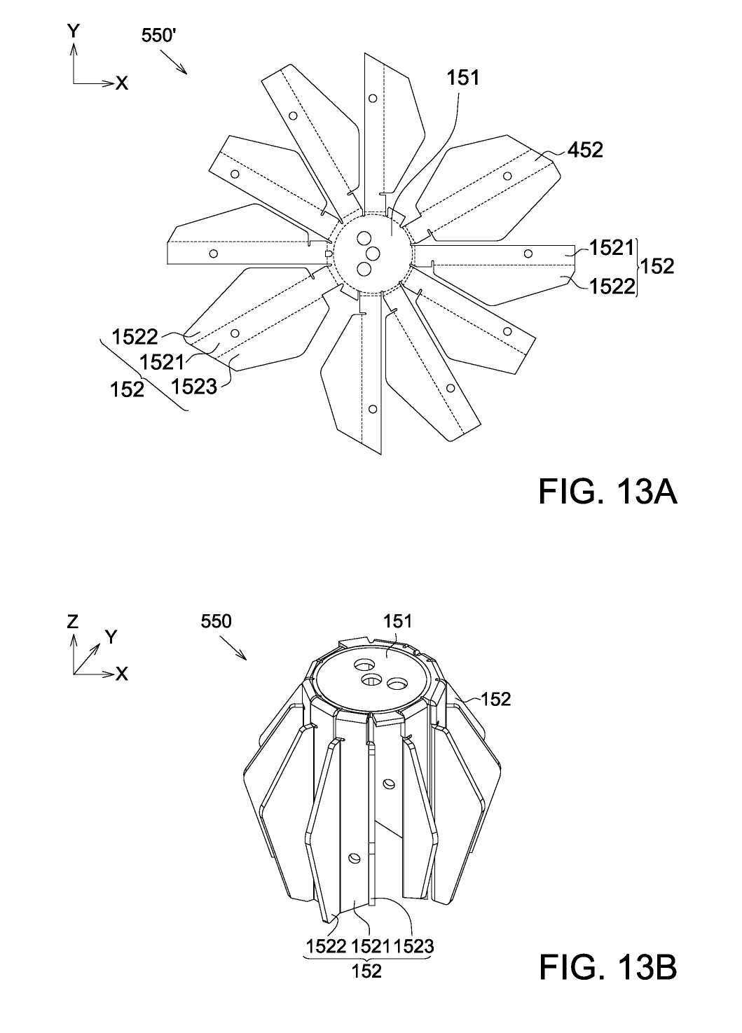

Refer to FIGS. 13A and 13B, FIG. 13A is an unfolding diagram of a single-piece heat dissipation element according to another embodiment of the invention, and FIG. 13B is a folding diagram of the single-piece heat dissipation element of FIG. 13A. Similarly, in comparison with the single-piece heat dissipation element 150 and 250, more heat conduction paths may be established by a single-piece heat dissipation element 550 or an unfolding sheet 550′ in the present embodiment.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A light-emitting device, comprising:
a single-piece heat dissipation element including a carrier and a fin portion;
a circuit board configured on the carrier; and
an electroinsulating casing encapsulating the carrier and the fin portion.

2. The light-emitting device according to claim 1, wherein the fin portion comprises:
an axial portion connecting to the carrier; and
a first radial portion outwardly extending from a first side of the axial portion.

3. The light-emitting device according to claim 2, wherein the fin portion further comprises:
a second radial portion outwardly extending from a second side of the axial portion;
wherein the electroinsulating casing includes a first covering portion and a second covering portion isolated from the first covering portion, the first covering portion encapsulates the first radial portion, the second covering portion encapsulates the second radial portion, and a heat dissipation recess is formed between the first covering portion and the second covering portion.

4. The light-emitting device according to claim 2, wherein the fin portion further comprises:
a circumferential portion circumferentially extending from the first radial portion.

5. The light-emitting device according to claim 1, wherein the fin portion has a fixing hole engaged with an engaging portion of the circumferential portion.

6. The light-emitting device according to claim 1, wherein the fin portion comprises:
a first fixing portion connecting to a first radial portion and extending toward a direction away from the first radial portion;
a second fixing portion connecting to a second radial portion and extending toward a direction away from the second radial portion so as to connect with a first fixing portion of adjacent another fin portion.

7. The light-emitting device according to claim 6, wherein the first fixing portion and the second fixing portion are circumferentially extended, one of the first fixing portion and the second fixing portion includes a protrusion, the other of the first fixing portion and the second fixing portion includes a notch, and the protrusion is engaged with the notch.

8. The light-emitting device according to claim 1, wherein the electroinsulating casing comprises:
a first convection hole; and
a second convection hole;
wherein the single-piece heat dissipation element is located between the first convection hole and the second convection hole.

9. The light-emitting device according to claim 1, further comprising:
a driver comprising a conductive wire;
wherein the electroinsulating casing includes an isolation portion located within a through hole of the carrier, and the conductive wire passes through a through hole of the isolation portion and is electrically isolated from the carrier by the isolation portion.

10. The light-emitting device according to claim 1, wherein the circuit board comprises:
an insulation layer; and
a heat conduction layer having a recess for receiving an isolation portion of the electroinsulating casing.
